(19) United States
(12) Patent Application Publication
(10) Pub. No.: US 2002/0031709 A1
(43) Pub. Date: Mar. 14, 2002

(54) Locking edge protector

(76) Inventor: William A. Ebert, Tucson, AZ (US)

Correspondence Address: Mark E. Ogram, 8040 S. Kolb Road, Tucson, AZ, 85706, US

(21) Appl. No.: 09/836,128

(22) Filed: Apr. 16, 2001

Related U.S. Application Data
(60) Provisional application No. 60/209,655, filed on Jun. 5, 2000.

(51) Int. Cl. H01M 2/18

(52) U.S. Cl. 429/246; 429/130

(57) ABSTRACT

An edge protector for an electrode used in electrowinning processes in the edge protector is secured to the cathode using a guide rail and then is sealed using an expansion pin. The edge protector has a slot which mates with the guide rail. The edge protector is slid over the guide rail until the edge protector is in proper position. Once the edge protector is properly positioned, an expansion pins is pressed (or pounded) into a receiving notch on the outer aspect of the edge protector. In response to the expansion pin's insertion, the opposing side of the edge protector (having the sealing teeth) is pressed against the face of the cathode.

### BACKGROUND OF THE INVENTION

Priority for this application is claimed from United States Provisional patent application serial number 60/209,655, filed on Jun. 5, 2000, and entitled “Edge Protector”.

This invention relates generally to refining processes and more particularly to cathode construction as used in electro-deposition processes.

In a typical electro-deposition process used for the refining of many minerals including copper, copper is extracted from the ore using large metal sheets made of titanium or stainless steel. These sheets are suspended in tanks containing the copper ore, a 5%-10% solution of sulfuric acid, plus other chemicals.

In Solvent Extraction-Electro Winning (SXEW), the copper is leached out of the copper bearing ore using sulfuric acid. The acid containing the copper drains to a collection system (pumps, pipes), ending up in tanks containing the large metal plates.

Low voltage/high amperage direct current electricity is applied, using lead as the anode, and the titanium/stainless steel plate as the cathode. The copper is electro-deposited (plated) on the metal to a pre-determined time/thickness.

Removal of the deposited copper requires the “peeling” of the copper from the cathode using a “knife” arrangement. Should the copper become deposited around the edge of the cathode, then its removal is significantly encumbered.

There is a significant need to provide for a mechanism which curtails depositing of the copper into a defined area. To this end, a variety of techniques have been developed including the use of various edge strips of CPVC, HDPE, Sponge/Spring combinations, etc.

All too often though, the edge strips break due to rough handling, copper getting underneath the strips, impact, age, etc. Protection such as wax, silicone, etc., must be reapplied each cycle; these are messy and create occupational and safety hazards, increase production costs.

Another problem associated with traditional edge strips is that when they are exposed to the high temperatures of their working environment, the maters used in the edge strip tend to degrade or unduly expand; this creates gaps in the seal between the edge protector and the cathode (allowing copper to be deposited in these gaps).

Gaps in the seals are also created during the grinding process to clean the cathode for subsequent uses. This narrows the width of the cathode; hence, the edge protector (designed for a particular width cathode) does not seal as well as it previously did.

When the edge strips break or fails to form a proper seal around the edge of the cathode, removal of the deposited copper is a major problem.

It is clear that there is a need for an improved method for controlling the deposit of ores onto cathodes.

### SUMMARY OF THE INVENTION

The present invention provides an edge protector for an electrode used in electrowinning processes in the edge protector sealed using an expansion pin. The electrode is a flat piece of metal, typically copper, which has its edges insulated by the present invention so that electro-deposition does not occur around the edges of the electrode.

In the preferred embodiment, the first step in assembling the completed electrode is the placement of a guide rail onto the electrode. The guide rail is secured to the surface of the electrode proximate to the edge which is to be insulated. Using screws or bolts, the guide rail is secured to the electrode.

The preferred embodiment uses two guide rails for each edge protector. This pair of guide rails are positioned on opposing faces of the electrode and are secured to each other using a bolt/nut combination.

The edge protector has a slot(s) which mates with the guide rail. The edge protector is slid over the guide rail until the edge protector is in proper position. This arrangement assures that a bumping of the edge protector will not dislodge or displace the edge protector from the electrode.

Once the edge protector is properly positioned, expansion pin(s) is/are pressed (or pounded) into a receiving notch on the outer aspect of the edge protector. The expansion pin is ideally circular in shape, but, other shapes are also acceptable, including a square shape.

In response to the expansion pin's insertion, the opposing side of the edge protector (having the sealing teeth) is pressed against the face of the cathode. This forms an extremely tight fit between the electrode and the edge protector which would not be obtainable otherwise.

In more detail, the present invention provides an edge protector which is secured to the cathode using a guide rail, and then is sealed using an expansion pin.

A guide rail is first secured to the edges of the cathode. The edge protector has a slot which mates with the guide rail. The edge protector is slid over the guide rail until the edge protector is in proper position.

Once the edge protector is properly positioned, an expansion pins is pressed (or pounded) into a receiving notch on the outer aspect of the edge protector. In response to the expansion pin's insertion, the opposing side of the edge protector (having the sealing teeth) is pressed against the face of the cathode.

In the preferred embodiment, the sealing teeth of the edge protector are narrow so that a secure seal between the working face of the cathode and the edge protector is assured.

Also in the preferred embodiment, the thermal expansion coefficient of the expansion pin is greater than the thermal expansion coefficient of the material used in the edge protector. This difference in the thermal expansion coefficient assures that as the assembly is heated, additional pressure is exerted onto the sealing teeth as the expansion pin expands.

The invention will be more clearly described by the accompanying drawings and the following descriptions thereof

### DRAWINGS IN BRIEF

FIGS. 1A, 1B, and 1C illustrate the application of the preferred embodiment onto a cathode.

FIG. 2 illustrates how the preferred embodiment of the edge protector is inserted onto the cathode.

FIG. 3 illustrates how the guide rails provide the primary securing mechanism for the edge protector.

FIGS. 4A and 4B illustrate the dimensional relationship within the preferred embodiment of the invention.

FIGS. 5A and 5B are side views of two embodiments of edge protectors of this invention.

FIG. 6 is a cut-away end view of an embodiment of the edge protector.

FIGS. 7A and 7B illustrate an embodiment of the invention which uses caps the end of the edge protectors.

### DRAWINGS IN DETAIL

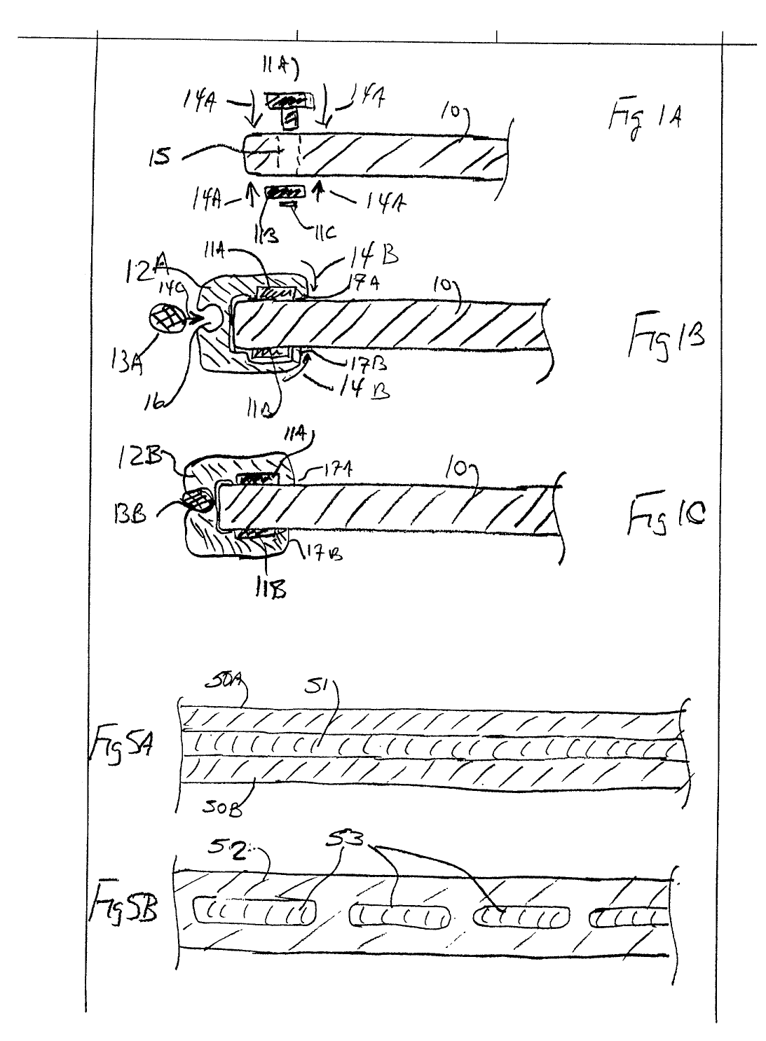

FIGS. 1A, 1B, and 1C illustrate the application of the preferred embodiment onto a cathode.

Referring to FIG. 1A, hole 15 within cathode 10 is designed to accept guide rails 11A and 11B. Guide rails 11A and 11B are assembled through hole 15 (as illustrated by arrows 14A) and secured to each other using fastener 11C.

In some embodiments, the guide rail extends on a single side of the cathode.

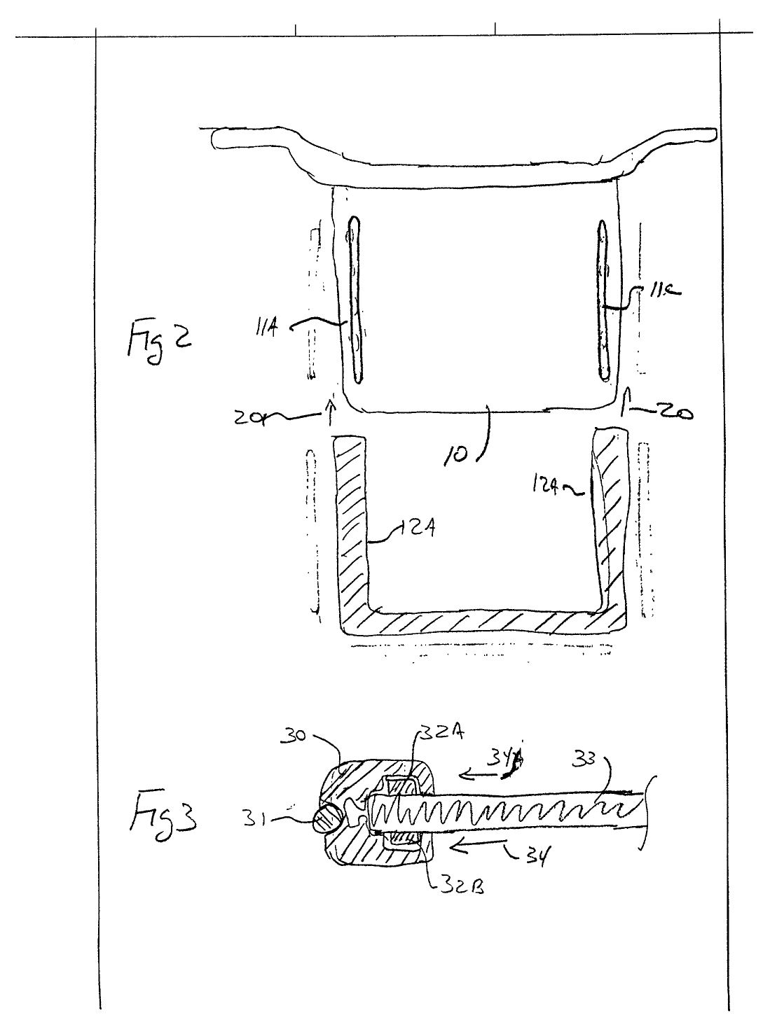

As shown in FIG. 1B, edge protector 12A is slid over guide rails 11A and 11B. Refer also to FIG. 2 which shows how edge protector 12A is inserted over guide rails 11A and 11C which have been secured to cathode 10.

Once edge protector 12A is properly positioned, expansion pin 13A causes sealing teeth 17A and 17B to move as indicated by arrows 14B.

Sealing teeth 17A and 17B engage the surface of cathode 10 causing a tight seal to be formed therebetween. Note, sealing teeth 17A and 17B do not extend the entire length over which edge protector 12A covers the edge of cathode 10. The width of sealing teeth 17A and 17B is intentionally kept small to create the best seal possible along the outer most edge of edge protector 12A.

FIG. 1C illustrates the fully assembled edge protector on the cathode.

Edge protector 12B, which has been clamped onto cathode 10 using expansion pin 13B, is fully engaged. Sealing teeth 17A and 17B have formed both a tight seal with cathode 10 and a frictional bond with cathode 10.

Guide rails 11A and 11B provide the primary mechanism for securing edge protector 12B to cathode 10.

FIG. 2 illustrates how the preferred embodiment of the edge protector is inserted onto the cathode.

Edge protector 12A is inserted over guide rails 11A and 11C which have been secured to cathode 10.

While this embodiment illustrates the use of an edge protector which has all three slides in a single unit, other embodiments of the inventions use single linear pieces which are sealed to each other after they have been assembled onto the cathode.

Even further embodiments of the invention utilize a single fastener which is applied through the top of each leg of the edge protector to further secure the edge protector to the cathode.

FIG. 3 illustrates how the guide rails provide the primary securing mechanism for the edge protector.

Cathode 33 has had edge protector 30 install thereon. As with the embodiment describe above, guide rails 32A and 32B are contained within edge protector 30. A seal between cathode 33 and edge protector 30 is established using expansion pin 31 which has been inserted into edge protector 30.

Once fully installed, bumps and other forces, illustrated by arrows 34, are unable to dislodge edge protector 30 as guide rails 32A and 32B prevent edge protector 30 from moving. In this manner, the guide rails become the primary mechanism for securing the edge protector to the guide rails.

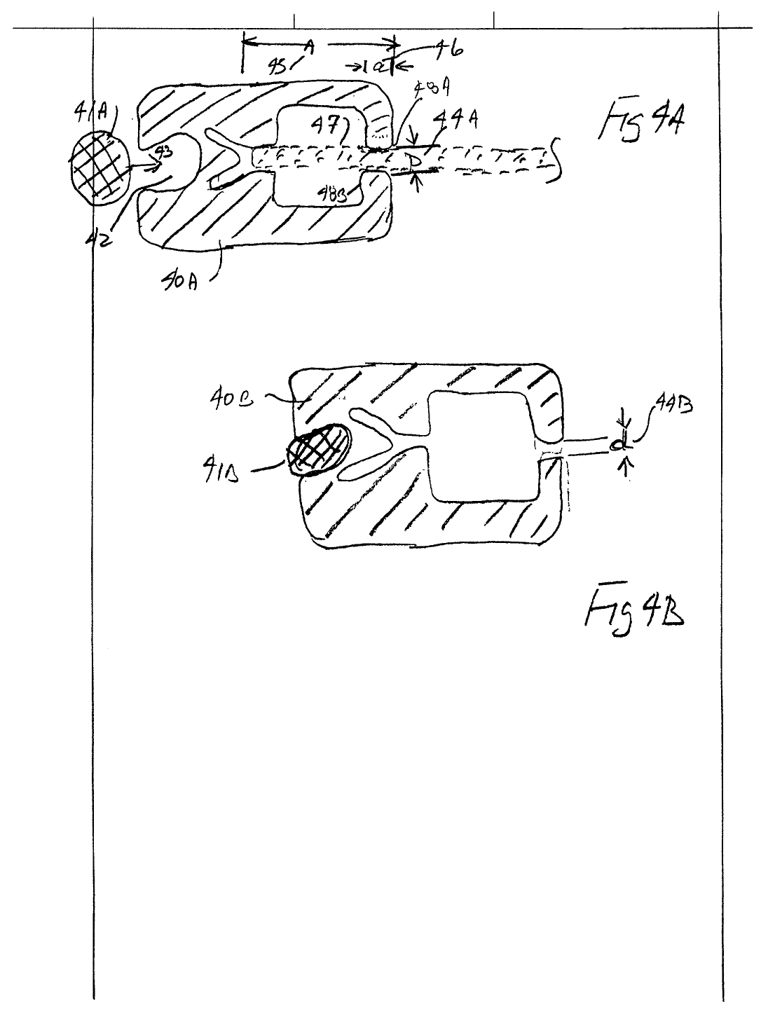

FIGS. 4A and 4B illustrate the dimensional relationship within the preferred embodiment of the invention.

For clarity of illustration, the guide rails are not shown in this illustration.

Cathode 47 extends through sealing teeth 48A and 48B for a distance “A”(45). Sealing teeth 48A and 48B have a width “a” (46). In the preferred embodiment, the ratio of a a/A is less than 25%. This ratio has been found to create an optimal sealing affect by sealing teeth 48A and 48B.

As sealing pin 41A is inserted into cavity 42 as illustrated by arrow 43, the distance “D” (44A) between sealing teeth 48A and 48B decreases to “d” (44B) as illustrated in FIG. 4B. The amount of reduction is defined by the physical characteristics of edge protector 40B and the size of expansion pin 41B.

In the preferred embodiment, the thermal expansion coefficient of the expansion pin 41B is greater than the thermal expansion coefficient of the material used in the edge protector 40B. This attribute assures that as the assembly is heated during operation, more pressure is exerted onto the sealing teeth 48A and 48B as expansion pin 41B expands.

FIGS. 5A and 5B are side views of two embodiments of edge protectors of this invention.

Referring to FIG. 5A, the edge protector has two upper surfaces 50A and 50B. Between these two surfaces is a receiving slot 51 which is configured to accept the expansion pin (not shown). In this embodiment, the expansion pin is a linear piece which extends substantially from end-to-end of the edge protector.

FIG. 5B illustrates another embodiment of the invention. In this embodiment, outer surface 52 is interrupted by a series of short receiving slot 53. Short expansion pins (not shown) are pressed into each receiving slot 53 to cause the edge protector to react as outlined above.

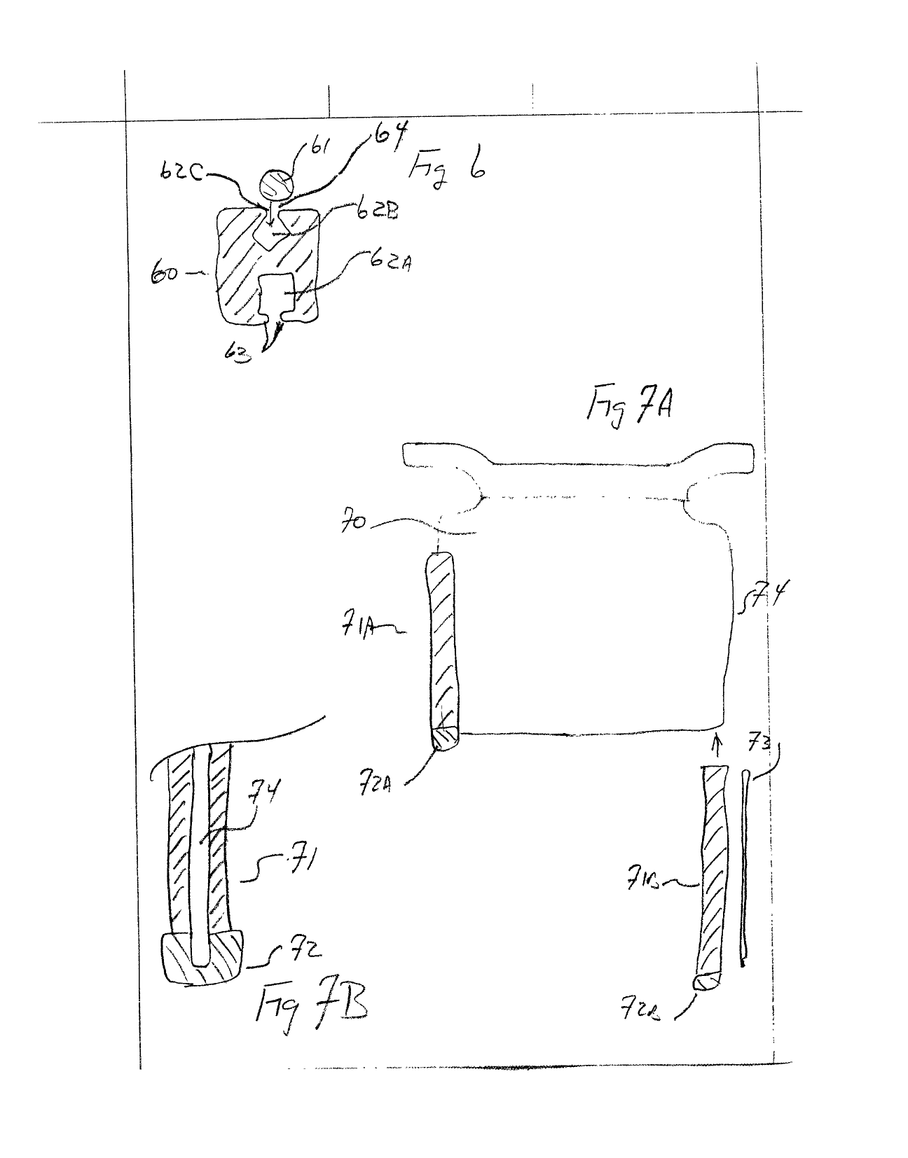

FIG. 6 is a cut-away end view of an embodiment of the edge protector.

Edge protector 60 has slit 62A into which the edge of the electrode is inserted. Teeth 63 are designed to engage the electrode (not shown) to form a seal between the electrode and edge protector 60 when the parts are fully assembled.

Internal channel 62B is attained through groove 62C by expansion pin 61 which is forced into internal channel 62B. The portion of edge protector 60 between internal channel 62B and slit 62A has sufficient flexibility such that when expansion pin 61 is inserted, teeth 63 firmly engage the electrode (not shown).

Note, in this embodiment, internal channel 62B has a generally square cross section. Those of ordinary skill in the art readily recognize that other shapes are possible in this context.

FIGS. 7A and 7B illustrate an embodiment of the invention which uses caps the end of the edge protectors.

Referring to FIG. 7A, electrode 70 has edge protector 71A already installed with edge protector 71B positioned to be slid onto electrode 70. Note that edge protectors 71A and 71B are each equipped with caps 72A and 72B which extend over and protect the corner of electrode 70.

Once edge protector 71B has been installed along edge 74, expansion pin 73 is inserted into edge protector 71B to cause the tightening edge protector 71B against the surfaces of electrode 70 as outlined above.

As shown in FIG. 7B, edge protector 71 has a slit 74 which receives the edge of the electrode. This slit communicates into end cap 72, thereby permitting end cap 72 to fully encircle the bottom corner of the electrode.

This embodiment of the invention is particularly useful for situations where no bottom edge protector is being applied to the electrode.

It is clear from the forgoing that the present invention creates a highly improved edge protector.

What is claimed is:

1. An edge protector kit for an electrode comprising:
a) an elongated strip having a slit along a first edge, said elongated strip further having a groove extending the length of said elongated strip along an opposing second edge of said elongated strip, said groove communicating with an internal channel having a diameter larger than a diameter of said groove; and,
b) an expansion pin configured to be inserted through said groove into said internal channel, a diameter of said expansion pin being larger than a diameter of said internal channel.

2. The edge protector kit according to claim 1, wherein said slit includes opposing ridges adapted to engage opposing faces of said electrode when installed along an edge of said electrode, said opposing ridges positioned along an outer aspect of said slit, each of said opposing ridges having a width substantially less than a depth of said slit.

3. The edge protector kit according to claim 2,
a) further including a first guide rail configured to be secured to a surface of said electrode proximate to an edge therethrough; and,
b) wherein said slit includes a first key channel configured to accept said first guide rail when said first guide rail and said elongated strip are secured to said electrode.

4. The edge protector kit according to claim 3,
a) further including a second guide rail configured to be secured to a surface of said electrode proximate to an edge thereof; and,
b) wherein said slit includes a second key channel configured to accept said second guide rail when said second guide rail and said elongated strip are secured to said electrode.

5. The edge protector kit according to claim 4, wherein said first guide rail and said second guide rail are adapted to be secured to opposing faces of said electrode.

6. The edge protector kit according to claim 5, wherein said first guide rail and said second guide rail are adapted to be secured to each other.

7. The edge protector kit according to claim 2, wherein a thermal expansion coefficient of said expansion pin is greater than a thermal expansion coefficient of the elongated strip.

8. The edge protector kit according to claim 2, wherein said expansion pin has a substantially circular cross section.

9. The edge protector kit according to claim 8, wherein said internal channel has a substantially circular cross section.

10. The edge protector kit according to claim 8, wherein said internal channel has a substantially square cross section.

11. The edge protector kit according to claim 8, wherein a length of said expansion pin is substantially equal to a length of said elongated strip.

12. The edge protector kit according to claim 2, wherein said elongated strip further includes an end-piece configured to encircle a corner of said electrode when said elongated strip is secured to said electrode.

13. The edge protector kit according to claim 2, wherein a portion of said elongated strip between said slit and said internal channel is elastic.

14. The edge protector kit according to claim 2, wherein a width of said slit is less than a width of said electrode.

15. An electrode comprising:
a) a flat sheet of metal;
b) an edge protector system having at least two edge protectors, each of said edge protectors having,
1) an elongated strip having a slit along a first edge through which an edge of said electrode extends, said elongated strip further having a groove extending the length of said elongated strip along an opposing second edge of said elongated strip, said groove communicating with an internal channel having a diameter larger than a diameter of said groove, and,
2) an expansion pin inserted through said groove into said internal channel, a diameter of said expansion pin being larger than a diameter of said internal channel.

16. The electrode according to claim 15, wherein said slit includes opposing ridges engaging opposing faces of said electrode, said opposing ridges positioned along an outer aspect of said slit, each of said opposing ridges having a width substantially less than a depth of said slit.

17. The electrode according to claim 16, wherein said edge protector system further includes:
a) a first guide rail secured to a surface of said electrode proximate to an edge therethrough; and,
b) wherein said slit includes a first key channel encasing said first guide rail.

18. The electrode according to claim 17, wherein said edge protector system further includes:
a) a second guide rail secured to a surface of said electrode proximate to an edge thereof; and,
b) wherein said slit further includes a second key channel encasing said second guide rail.

19. The electrode according to claim 16, wherein a thermal expansion coefficient of said expansion pin is greater than a thermal expansion coefficient of the elongated strip.

20. The electrode according to claim 16, wherein each elongated strip further includes an end-piece configured to encircle a corner of said flat sheet of metal.
